(19) United States
(12) Patent Application Publication
(10) Pub. No.: US 2014/0294225 A1
(43) Pub. Date: Oct. 2, 2014

(54) ENCLOSURE SPEAKER WITH SIDE ACOUSTIC EMISSION STRUCTURE

(71) Applicant: EM-TECH Co., Ltd., Busan (KR)

(72) Inventors: Yong Ju Ji, Gimhae-si (KR); Jin Geon Son, Changwon-si (KR); Hyun Woo Lee, Changwon-si (KR)

(73) Assignee: EM-TECH Co., Ltd., Busan (KR)

(21) Appl. No.: 14/227,396

(22) Filed: Mar. 27, 2014

(30) Foreign Application Priority Data
Mar. 28, 2013 (KR) 10-2013-0033427

(51) Int. Cl. H04R 1/02

(52) U.S. Cl. CPC H04R 1/021
USPC 381/386

(57) ABSTRACT

An enclosure speaker with a side acoustic emission structure is provided, which includes: a microspeaker; a lower enclosure case, on which the microspeaker is seated, the lower enclosure case further having a resonance space on the outside of the microspeaker-seated portion; an upper enclosure case coupled to a top of the lower enclosure case; an acoustic passage, a first portion of which being defined in the lower enclosure case and a remaining portion of which being defined in the upper enclosure case, the acoustic passage being made by combining the portion defined in the lower enclosure case and the portion defined in the upper enclosure case; and a mesh disposed on the acoustic passage between the lower enclosure case and the upper enclosure case.

### PRIORITY CLAIM

The present application claims priority to Korean Patent Application No. 10-2013-0033427 filed on 28 Mar. 2013, the content of said application incorporated herein by reference in its entirety.

### TECHNICAL FIELD

The present invention relates to an enclosure speaker with a side acoustic emission structure, and more particularly, to an enclosure speaker with a side acoustic emission structure, which improves an attachment structure of a mesh for preventing foreign materials from being introduced into a side sound-emitting hole.

### BACKGROUND

FIG. 1 is a perspective view showing a conventional enclosure speaker with a side acoustic emission structure, FIG. 2 is an exploded perspective view showing the conventional enclosure speaker with the side acoustic emission structure, FIG. 3 is a sectional view showing the conventional enclosure speaker with the side acoustic emission structure, and FIG. 4 is a view showing a microspeaker provided in the enclosure speaker with the side acoustic emission structure.

The conventional enclosure speaker with the side acoustic emission structure includes a microspeaker 10, a lower enclosure case 20, an upper enclosure case 30, and a mesh 40. The lower enclosure case 20 has a stepped portion 22, at the center of which the microspeaker 10 is positioned, and a resonance space 24 surrounding the microspeaker 10, while the upper enclosure case 30 has a fixing portion 32 for fixedly pressing the microspeaker 10 from the top, a resonance space 34 defined above the microspeaker, an acoustic passage 36 connected to the resonance space 34, and a sound-emitting hole 38 disposed in front of the acoustic passage 36.

Referring to FIG. 4, the microspeaker 10 provided in the enclosure speaker includes a magnet circuit having a yoke (not shown) and a magnet (not shown) in a frame 1, a voice coil disposed in an air gap of the magnetic circuit, a side diaphragm 4a and a center diaphragm 4b vibrated by a voice coil (not shown), a suspension for guiding the movement of the voice coil (not shown) and the diaphragms 4a and 4b, and an inner terminal 7 for receiving electrical signals from the outside and transferring the electrical signals to the voice coil (not shown) through the suspension 5. The microspeaker 10 provided in the enclosure speaker, unlike a general microspeaker, does not have a protector coupled to the top of the frame 1. Due to its side acoustic emission structure, the mesh 40 is attached, covering the sound-emitting hole 38 of the upper enclosure case 30, to prevent foreign materials from being introduced into the microspeaker 10, rather than coupling the protector to the top of the diaphragms 4a and 4b and forming the sound-emitting hole at the center of the protector.

However, if the user carelessly handles the enclosure speaker, the mesh 4, which is attached to the outside of the enclosure case, may be damaged or separated. In addition, the attachment surface of the mesh 4 should be made planar for ease of attachment of the mesh, which leads to external design limitations of the enclosure case.

### SUMMARY

According to embodiments described herein, an enclosure speaker is provided with a side acoustic emission structure, which can easily make external design changes to an enclosure case, by changing an attachment position and attachment structure of a mesh.

According to an embodiment, there is provided an enclosure speaker with a side acoustic emission structure, the enclosure speaker including: a microspeaker; a lower enclosure case, on which the microspeaker is seated, the lower enclosure case further having a resonance space on the outside of the microspeaker-seated portion; an upper enclosure case coupled to the top of the lower enclosure case; an acoustic passage, a first portion of which being defined in the lower enclosure case and a remaining portion of which being defined in the upper enclosure case, the acoustic passage being made by combining the portion defined in the lower enclosure case and the portion defined in the upper enclosure case; and a mesh disposed on the acoustic passage between the lower enclosure case and the upper enclosure case.

In some embodiments, the coupling surface of the upper enclosure case and the lower enclosure case which define the acoustic passage is slanted.

According to another aspect of the present invention, there is provided an enclosure speaker with a side acoustic emission structure, the enclosure speaker including: a microspeaker; a lower enclosure case, on which the microspeaker is seated, the lower enclosure case having a first protruding portion protruding to the outside by a certain section; an upper enclosure case coupled to the top of the lower enclosure case to define a resonance space and having a second protruding portion coupled to the first protruding portion; an acoustic passage defined through the first protruding portion and the second protruding portion; and a mesh disposed on the acoustic passage between the first protruding portion and the second protruding portion.

In some embodiments, any one of the first protruding portion and the second protruding portion is extended more outwardly from the coupling surface.

In some embodiments, the more outwardly-extended protruding portion has a first coupling surface to be coupled to the outside of the other protruding portion and a second coupling surface to be coupled to the top or bottom of the other protruding portion.

In some embodiments, the mesh is mounted on the first coupling surface.

In some embodiments, in the enclosure case having the more outwardly-extended protruding portion, the protruding portion or the outer surface including the protruding portion is formed as a curved surface.

The enclosure speaker with the side acoustic emission structure according to the present invention includes two extensions for defining the acoustic passage in the upper enclosure case and the lower enclosure case, the mesh being mounted on the coupling surface of the two extensions and being not attached to the outside of the enclosure speaker, and thus advantageously realizes various external designs, unlike the conventional enclosure speaker which should have a planar surface on the enclosure case for the purpose of the attachment of the mesh.

Moreover, the enclosure speaker with the side acoustic emission structure according to the present invention safely secures the mesh, because the mesh is not attached to the outside of the enclosure speaker.

Those skilled in the art will recognize additional features and advantages upon reading the following detailed description, and upon viewing the accompanying drawings.

### BRIEF DESCRIPTION OF THE DRAWINGS

The elements of the drawings are not necessarily to scale relative to each other. Like reference numerals designate corresponding similar parts. The features of the various illustrated embodiments can be combined unless they exclude each other. Embodiments are depicted in the drawings and are detailed in the description which follows.

FIG. 1 is a perspective view showing a conventional enclosure speaker with a side acoustic emission structure;

FIG. 2 is an exploded perspective view showing the conventional enclosure speaker with the side acoustic emission structure;

FIG. 3 is a sectional view showing the conventional enclosure speaker with the side acoustic emission structure;

FIG. 4 is a view showing a microspeaker provided in the enclosure speaker with the side acoustic emission structure;

FIG. 5 is a perspective view showing an enclosure speaker with a side acoustic emission structure according to a first embodiment of the present invention;

FIG. 6 is an exploded perspective view showing the enclosure speaker with the side acoustic emission structure according to the first embodiment of the present invention;

FIG. 7 is a sectional view showing the enclosure speaker with the side acoustic emission structure according to the first embodiment of the present invention;

FIG. 8 is a perspective view showing an enclosure speaker with a side acoustic emission structure according to a second embodiment of the present invention, when seen from the bottom;

FIG. 9 is a sectional view showing the enclosure speaker with the side acoustic emission structure according to the second embodiment of the present invention;

FIG. 10 is a comparative view showing the area of the mesh of the speaker with the side acoustic emission structure according to the prior art and the area of the mesh of the speaker with the side acoustic emission structure according to one embodiment of the present invention;

FIG. 11 is a view showing an example in which a mesh is attached to an outer surface of a protruding portion of an upper enclosure case of an enclosure speaker with a side acoustic emission structure according to one embodiment of the present invention; and

FIG. 12 is a view showing another example in which a mesh is attached to an outer surface of a protruding portion of an upper enclosure case of an enclosure speaker with a side acoustic emission structure according to one embodiment of the present invention.

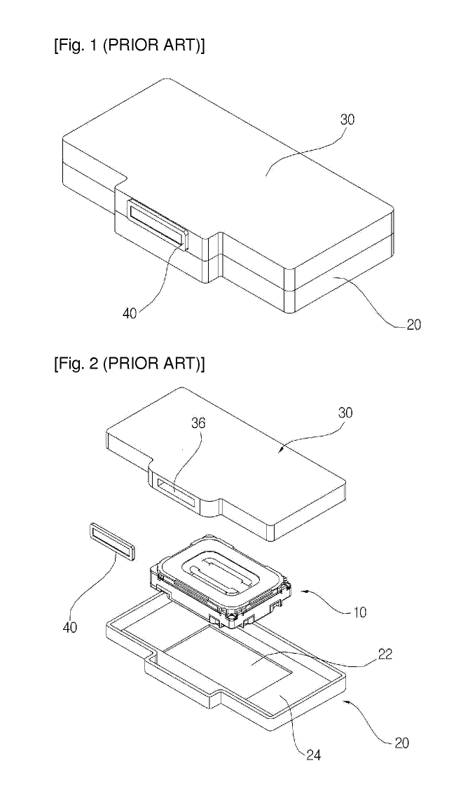

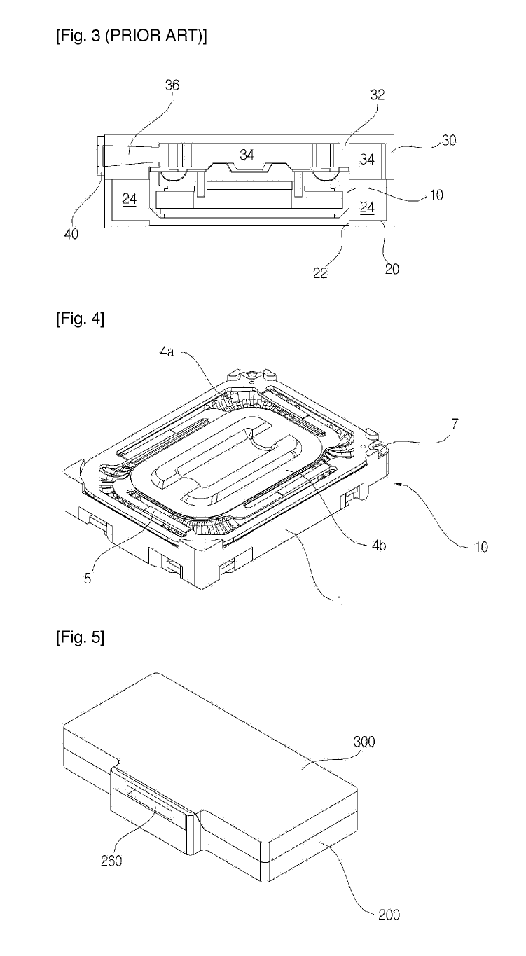

### DETAILED DESCRIPTION

Hereinafter, an enclosure speaker with a side acoustic emission structure according to the present invention will be described in more detail with reference to the accompanying drawings.

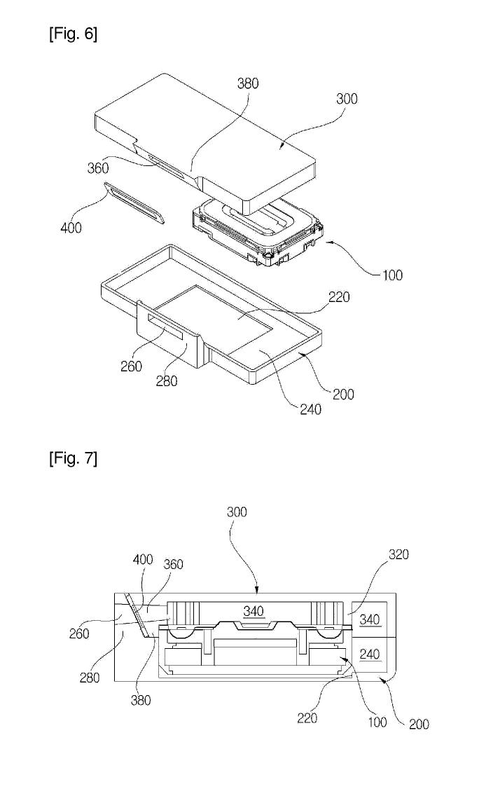

FIG. 5 is a perspective view showing an enclosure speaker with a side acoustic emission structure according to a first embodiment of the present invention, FIG. 6 is an exploded perspective view showing the enclosure speaker with the side acoustic emission structure according to the first embodiment of the present invention, and FIG. 7 is a sectional view showing the enclosure speaker with the side acoustic emission structure according to the first embodiment of the present invention.

The enclosure speaker with the side acoustic emission structure according to the first embodiment of the present invention includes a microspeaker 100, a lower enclosure case 200, an upper enclosure case 300, and a mesh 400.

The lower enclosure case 200 has a seating portion 220 at the center, so that the microspeaker 100 can be seated thereon. The seating portion 220 has a stepped portion for guiding the microspeaker 100 to the seating position. A resonance space, which is an empty space, is defined around the seating portion 220. A first protruding portion 280 protrudes outwardly from one side of the lower enclosure case 200 in the manner of defining an acoustic passage 260.

The upper enclosure case 300 is coupled to the lower enclosure case 200 and provided with a fixing portion 320, such as a rib, which fixedly presses the microspeaker 100 from the top, and a resonance space 340, which is an empty space. In addition, a second protruding portion 380 protrudes outwardly from one side of the upper enclosure case 300 in the manner of defining an acoustic passage 360, and is coupled to the first protruding portion 280.

The second protruding portion 380 is shorter than the first protruding portion 280 and is coupled to the top of the first protruding portion 280. The coupling surface in which the first protruding portion 280 is coupled to the second protruding portion 380 consists of a first coupling surface, in which the top surface of the first protruding portion 280 is coupled to the bottom surface of the second protruding portion 380, and a second coupling surface, in which the portion of the first protruding portion 280 that is more extended than the second protruding portion 380 is coupled to the outer surface of the second protruding portion 380. The mesh 400 is mounted on the second coupling surface.

A first portion 260 of the acoustic passage is defined in the lower enclosure case 200, while a remaining portion 360 is defined in the upper enclosure case 300. That is, the acoustic passage 260 defined in the first protruding portion 280 and the acoustic passage 360 defined in the second protruding portion 380 are combined to the whole acoustic passage. The mesh 400 is mounted on the acoustic passage 260 and 360 to cross it and disposed between the acoustic passage 260 defined in the first protruding portion 280 and the acoustic passage 360 defined in the second protruding portion 380.

Although the acoustic passage 360 defined in the lower enclosure case 200 is more outwardly disposed in the first embodiment of the present invention, it may be more inwardly disposed. That is, it is conceivable that the second protruding portion 380 provided on the upper enclosure case 300 is more outwardly extended than the first protruding portion 280, and that the more extended portion of the second protruding portion 380 is coupled to the outside of the first protruding portion 280.

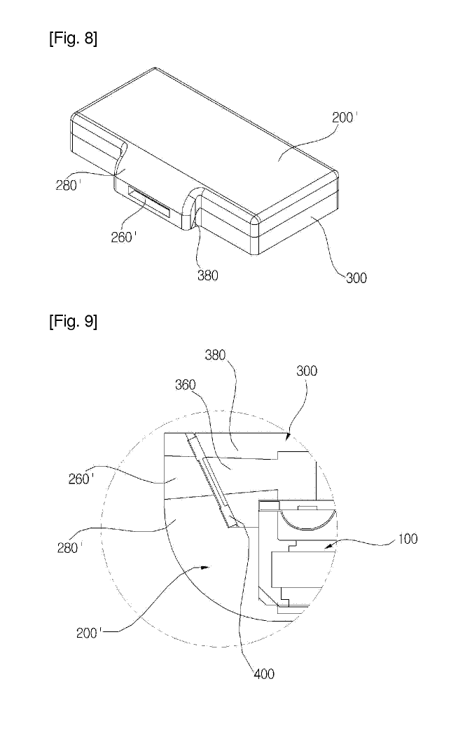

FIG. 8 is a perspective view showing an enclosure speaker with a side acoustic emission structure according to a second embodiment of the present invention, when seen from the bottom, and FIG. 9 is a sectional view showing the enclosure speaker with the side acoustic emission structure according to the second embodiment of the present invention. The configuration other than the lower enclosure case 200′ is identical to that of the first embodiment, and thus a detailed description thereof is omitted.

In the enclosure speaker with the side acoustic emission structure according to the second embodiment of the present invention, a protruding portion 280′ of a lower enclosure case 200′ and an outer surface around the protruding portion 280′ are formed as a curved surface. A mesh 400 is not mounted on the outer surface of the enclosure case 200′ and 300, but mounted inside, so a planar surface which is at least larger than the mesh 400 is not required for the purpose of the attachment of the mesh 400. Therefore, the external design of the enclosure case 200′ and 300 is flexible. As a result, its outer surface can be designed as the curved surface as in the second embodiment.

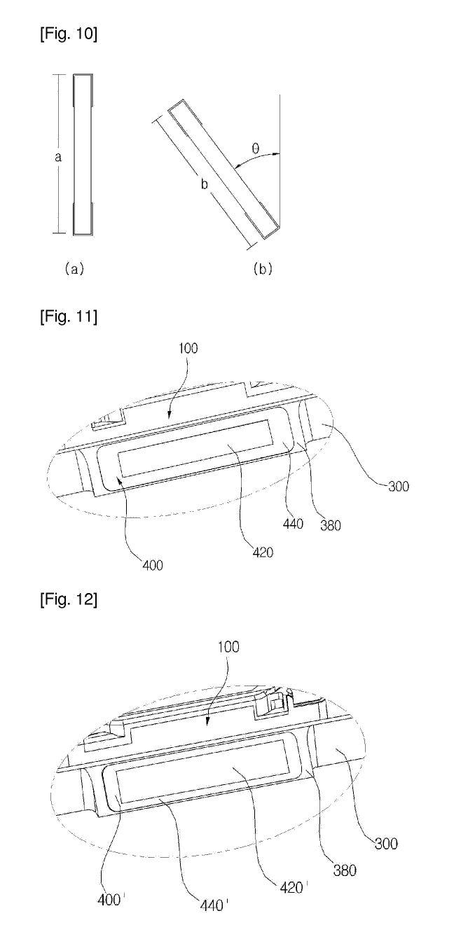

FIG. 10 is a comparative view showing the area of the mesh of the speaker with the side acoustic emission structure according to the prior art and the area of the mesh of the speaker with the side acoustic emission structure according to one embodiment of the present invention. Referring to FIGS. 5 to 9, in the speakers with the side acoustic emission structures according to the first and second embodiments of the present invention, the second coupling surface is a slanted surface. Here, with respect to the area of the mesh 400 (see FIGS. 5 to 9), length ‘b’ of the mesh 400 when the second coupling surface is slanted at an angle of θ and length ‘a’ when the second coupling surface is vertical satisfy b =a/sinθ. When it is assumed that the width is constant, the area is also 1 sin θ times, as compared with ‘a’. Typically, the magnitude of the sound is expressed in dB and represented as a sound pressure level or efficiency in the speaker system. This means ‘the average magnitude of the sound that can be heard 1 m from the speaker, when an output of 1 w (2.83v) is transferred from an amplifier to the speaker’. Therefore, the greater the sound pressure is, the greater the reproduced sound is with the same output of the amplifier.

In low frequencies having a relatively large amplitude, an amount of pushing the air increases. As the air passes through a narrow line, its resistivity increases, which degrades low sound characteristics. If the effective area of the sound-emitting hole is reduced to make the enclosure speaker slimmer, the SPL at low sounds is reduced. The effective area is the area in which the mesh on the sound-emitting side is perforated on the surface perpendicular to the sound-proceeding direction. The smaller this area is, the poorer the low frequency performance is. In the enclosure speaker with the side acoustic emission structure according to the present invention, the effective area of the mesh 400 is increased on the acoustic passage, which improves the SPL performance. FIG. 11 is a view showing an example in which a mesh is attached to an outer surface of a protruding portion of an upper enclosure case of an enclosure speaker with a side acoustic emission structure according to one embodiment of the present invention, and FIG. 12 is a view showing another example in which a mesh is attached to an outer surface of a protruding portion of an upper enclosure case of an enclosure speaker with a side acoustic emission structure according to one embodiment of the present invention. As described earlier, the mesh 400 of FIG. 11 is mounted on the second coupling surface, which is a surface slanted at a certain angle. Accordingly, the coupling surface of the upper enclosure case 300, i.e., the outer surface of the protruding portion 380 is a slanted surface. The mesh 400 is attached to the coupling surface of the upper enclosure case 300. As far as the shape of the protruding portion 380 permits, the coupling surface may be slanted at any angle. Referring again to FIG. 10, the angle θ is greater than 0° and smaller than 90°. It can be expected that the greater the angle θ is, the greater the area of the coupling surface is. The angle θ can be arbitrarily given, so any slanted surface can be provided on the protruding portion 380. This slanted surface is formed as a planar surface, so there is no difficulty in attaching the mesh 400 to this surface. The mesh 400 is attached to the outer surface of the protruding portion 380 by a double-sided tape 440. The size of the attachment surface of the double-sided tape 440 and the size of the exposed surface 420 of the mesh 400 can also be changed in various ways. In the example of FIG. 11, the size of the exposed surface 420 is equivalent to the size of the acoustic passage 380. Meanwhile, in the example of FIG. 12, the size of the exposed surface 420′ is larger than the size of the acoustic passage 380, but the size of the attachment surface of the double-sided tape 440′ is reduced. That is, under the condition that the size of the exposed surface 420 and 420′ is larger than the size of the acoustic passage 380 and 380′, the attachment surface of the double-sided tape 440 and 440′and the size of the exposed surface 420 and 420′ can be freely changed as needed.

Spatially relative terms such as “under”, “below”, “lower”, “over”, “upper” and the like, are used for ease of description to explain the positioning of one element relative to a second element. These terms are intended to encompass different orientations of the device in addition to different orientations than those depicted in the figures. Further, terms such as “first”, “second”, and the like, are also used to describe various elements, regions, sections, etc. and are also not intended to be limiting. Like terms refer to like elements throughout the description.

As used herein, the terms “having”, “containing”, “including”, “comprising” and the like are open-ended terms that indicate the presence of stated elements or features, but do not preclude additional elements or features. The articles “a”, “an” and “the” are intended to include the plural as well as the singular, unless the context clearly indicates otherwise.

With the above range of variations and applications in mind, it should be understood that the present invention is not limited by the foregoing description, nor is it limited by the accompanying drawings. Instead, the present invention is limited only by the following claims and their legal equivalents.

What is claimed is:

1. An enclosure speaker with a side acoustic emission structure, the enclosure speaker comprising:
a microspeaker;
a lower enclosure case, on which the microspeaker is seated, the lower enclosure case further having a resonance space on the outside of the microspeaker-seated portion;
an upper enclosure case coupled to a top of the lower enclosure case;
an acoustic passage, a first portion of which being defined in the lower enclosure case and a remaining portion of which being defined in the upper enclosure case, the acoustic passage being made by combining the portion defined in the lower enclosure case and the portion defined in the upper enclosure case; and
a mesh disposed on the acoustic passage between the lower enclosure case and the upper enclosure case.

2. The enclosure speaker of claim 1, wherein a coupling surface of the upper enclosure case and the lower enclosure case which define the acoustic passage is slanted.

3. An enclosure speaker with a side acoustic emission structure, the enclosure speaker, comprising:
a microspeaker;
ca lower enclosure case, on which the microspeaker is seated, the lower enclosure case having a first protruding portion protruding to one side;
an upper enclosure case coupled to a top of the lower enclosure case to define a resonance space and having a second protruding portion coupled to the first protruding portion of the lower enclosure case;
an acoustic passage defined through the first protruding portion and the second protruding portion; and
a mesh disposed on the acoustic passage between the first protruding portion and the second protruding portion.

4. The enclosure speaker of claim 3, wherein any one of the first protruding portion and the second protruding portion is extended more outwardly from a coupling surface.

5. The enclosure speaker of claim 4, wherein the more outwardly-extended one of the first protruding portion and the second protruding portion has a first coupling surface to be coupled to an outside of the other protruding portion and a second coupling surface to be coupled to a top or bottom of the other protruding portion.

6. The enclosure speaker of claim 5, wherein the mesh is mounted on the first coupling surface.

7. The enclosure speaker of claim 4, wherein, in the enclosure case having the more outwardly-extended protruding portion, the protruding portion or the outer surface including the protruding portion is formed as a curved surface.
